(19) United States
(12) Patent Application Publication
(10) Pub. No.: US 2006/0041601 A1
(43) Pub. Date: Feb. 23, 2006

(54) Method and apparatus for synchronizing metadata, and storage medium storing computer program for executing the method

(75) Inventors: Hee-yeon Kim, Suwon-si (KR); Du-il Kim, Suwon-si (KR); Jin-yong Ahn, Suwon-si (KR); Hyok-sung Choi, Yongin-si (KR); Seong-kook Shin, Seoul (KR); Young-yoon Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/124,127

(22) Filed: May 9, 2005

Related U.S. Application Data
(60) Provisional application No. 60/568,671, filed on May 7, 2004.

(30) Foreign Application Priority Data
Jun. 25, 2004 (KR) 10-2004-0048210

(51) Int. Cl. G06F 17/30; G06F 7/00; G06F 17/21

(52) U.S. Cl. 707/201; 707/102; 715/500.1; 715/501.1

(57) ABSTRACT

A method and apparatus for synchronizing metadata of different assets referencing the same contents, using a backward-link information file of an asset when metadata of the asset is edited, the method including: editing a metadata of a first asset; detecting a second asset referencing the same content as the first asset using a backward-link information file of content which the first asset refers to; and synchronizing metadata of the second asset with the edited metadata of the first asset. Therefore, it is possible to easily synchronize metadata of assets in a plurality of MPV files referencing the same content.

This application claims the priorities of Korean Patent Application No. 10-2004-0048210, filed on Jun. 25, 2004 in the Korean Intellectual Property Office, and of U.S. Patent Application No. 60/568,671, filed on May 7, 2004, in the U.S. Patent and Trademark Office, the disclosures of which are incorporated herein in their entireties by reference.

### BACKGROUND OF THE INVENTION

1. Field of the Invention

The present invention relates to synchronization metadata, and more particularly, to a method and apparatus for synchronizing metadata of assets in a plurality of MultiPhotoVideo or MusicPhotoVideo (hereinafter, referred to as ‘MPV’) files which reference (or link) the same content, and a storage medium storing a computer program for executing the method.

2. Description of the Related Art

Various schemes have been proposed to share and exchange content between Information Technologies (ITs) or Consumer Electronics (CE) products processing digital data content. Such schemes include MultiPhotoVideo or MusicPhotoVideo (hereinafter, referred to as ‘MPV’).

The MPV, which is an Open Specification, is standardized in the Optical Storage Technology Association (OSTA) and International Imaging Industry Association (I3A) and is aimed to facilitate processing, exchanging and reproducing of content, such as digital photos, videos, digital audios and texts.

Assets of XML-based metadata such as the MPV metadata are linked by parent indexes or albums. Such link is described by an XML and is a one-way referenced link going from a parent asset to a child asset.

That is, referring to an example of ‘MPV Link’ shown in FIG. 1, an asset /DCIM/100ABCDE/SAMS0001.JPG is linked to a file album001.pvm and an asset /DCIM/100ABCDE/SAMS0002.JPG is linked to the file album001.pvm and a file album002.pvm. An asset /DCIM/101ABCDE/SAMS0001.JPG is linked to the file album002.pvm and a file index.pvm and an asset /DCIM/101ABCDE/SAMS0001.WAV is linked to the file index.pvm.

Accordingly, a source code of the file index.pvm of FIG. 1 can be described by the XML, as shown in FIG. 2. Referring to FIG. 2, ‘mpv:id’ of the asset /DCIM/101ABCDE/SAMS0001.JPG in the file index.pvm is written to “MariahPhoto00”, ‘mpv:id’ of the asset /DCIM/101ABCDE/SAMS0001.WAV is written to “MariahSong00”, and ‘mpv:id’ of an asset StillWithAudio is written to “MariahAlbum00”.

A source code of the file album002.pvm of FIG. 1 can be described by the XML, as shown in FIG. 3. Referring to FIG. 3, in the file album002.pvm, ‘mpv:id’ of the asset /DCIM/101ABCDE/SAMS0001.JPG is written to “MariahPhoto00” and ‘mpv:id’ of the asset /DCIM/100ABCDE/SAMS0002.JPG is written to “MandyMoorePhoto00”.

Referring to source code examples shown in FIGS. 2 and 3, ‘mpv:id’ of the asset DCIM/101ABCDE/SAMS0001.JPG is written to “MariahPhoto00” in both the files index.pvm and album0002.pvm. In this case, if metadata of the asset DCIM/101ABCDE/SAMS0001.JPG is edited in the file index.pvm, metadata of the asset DCIM/101ABCDE/SAMS0001.JPG will have different content from metadata of the asset DCIM/101ABCDE/SAMS0001.JPG of the file album002.pvm.

That is, although in the file index.pvm, <title> which is metadata of the asset DCIM/101ABCDE/SAMS0001.JPG in which ‘mpv:id’ references “MariahPhoto00” changes from “Beautiful Mariah” to “Mariah in Korea”, in the file album0002.pvm, <title> which is metadata of the asset DCIM/110ABCDE/SAMS0001.JPG in which ‘mpv:id’ references “MariahPhoto00” still remains “Beautiful Mariah”. Accordingly, contradiction is generated between metadata of the file album0002.pvm and that of the file index.pvm linked to the asset DCIM/101ABCDE/SAMS0001.JPG.

This contradiction occurs because the one-way referenced link mentioned above is used and an asset does not know information for an interrelated asset. Therefore, to remove contradiction between metadata of assets referencing the same content in different MPV files, when metadata is edited, metadata of all assets should be checked.

### SUMMARY OF THE INVENTION

The present invention provides a method and apparatus for synchronizing metadata of different assets referencing the same content, using backward-link information file of the asset when the metadata of the asset is edited, and a storage medium storing a computer program for executing the method.

According to an aspect of the present invention, there is provided a method for synchronizing metadata, the method comprising: editing a metadata of a first asset; detecting a second asset referencing the same content as the first asset using a backward-link information file of content which the first asset refers to; and synchronizing metadata of the second asset with the edited metadata of the first asset.

According to another aspect of the present invention, there is provided a method for synchronizing metadata of assets in a system including an MPV file unit and a backward-link information file unit, the method comprising: editing metadata of a first asset; searching for a backward-link information file of a content which the first asset refers to, in the backward-link information file unit; determining whether a second asset detected from the MPV file unit based on the backward-link information file references the same content as the first asset; and if the second asset references the same content as the first asset, synchronizing metadata of the second asset with the edited metadata of the first asset.

According to still another aspect of the present invention, there is provided an apparatus for synchronizing metadata, the apparatus comprising: an MPV file unit having information for at least one asset; a metadata editing unit editing metadata of a first asset; a backward-link information file unit having a backward-link information file of at least one content; a search unit searching for a backward-link information file of a content which the first asset refers to, in the backward-link information file unit based on information of the first asset provided from the metadata editing unit; an asset detector detecting a second asset referencing the same content as the first asset using the searched backward-link information file and the information included in the MPV file unit; and a synchronization processor synchronizing metadata of the second asset with the edited metadata of the first asset.

According to still yet another aspect of the present invention, there is provided a computer-readable medium having embodied thereon a computer program for executing a method for synchronizing metadata, the method comprising: editing metadata of a first asset; detecting a second asset referencing the same content as the first asset using a backward-link information file of a content which the first asset refers to; and synchronizing metadata of the second asset with the edited metadata of the first asset.

### BRIEF DESCRIPTION OF THE DRAWINGS

The above and other features and advantages of the present invention will become more apparent by describing in detail exemplary embodiments thereof with reference to the attached drawings in which:

FIG. 1 shows an example of MPV Link;

FIG. 2 shows an example of a source code of a file index.pvm shown in FIG. 1;

FIG. 3 shows an example of a source code of a file album002.pvm shown in FIG. 1;

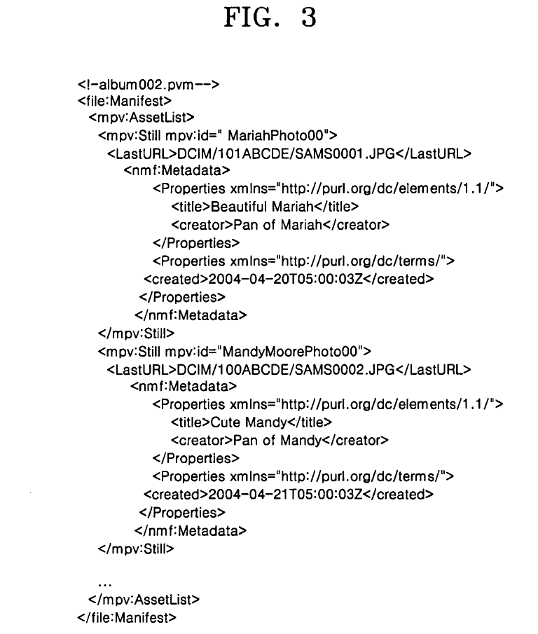

FIG. 4 is a functional block diagram of a system including a metadata synchronization apparatus according to an embodiment of the present invention;

FIG. 5 shows an example of a source code of a file mtd; and

FIG. 6 is a flowchart illustrating a metadata synchronization method according to an embodiment of the present invention.

### DETAILED DESCRIPTION OF THE INVENTION

Hereinafter, embodiments of the present invention will be described in detail with reference to the appended drawings. The same reference numbers refer to the same components throughout the drawings.

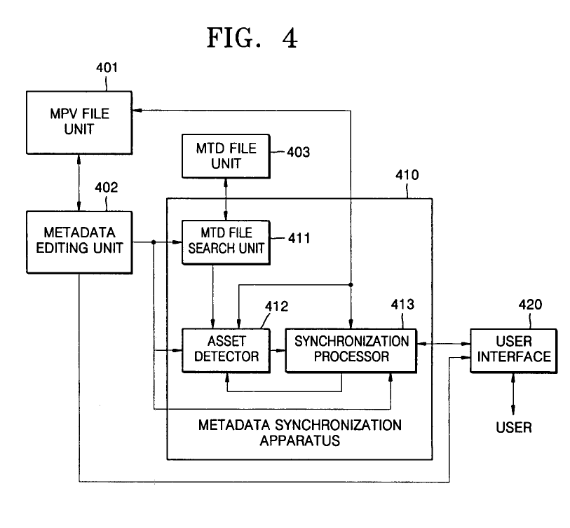

FIG. 4 is a functional block diagram of a system including a metadata synchronization apparatus according to an embodiment of the present invention. Referring to FIG. 4, the system includes an MPV file unit 401, a metadata editing unit 402, an mtd file unit 403, a metadata synchronization apparatus 410 and a user interface 420. The system may be a capturing device for capturing digital media or a digital media reproduction system.

The MPV file unit 401, as a group of files described by an XML (extended Markup Language), includes files of *.pvm, *.mum, *.xml, etc.

The metadata editing unit 402 can edit metadata of an asset in an MPV file included in the MPV file unit 401 according to a user request received via the user interface 420. The editing operation may include creating, copying, removing, modifying and moving of metadata.

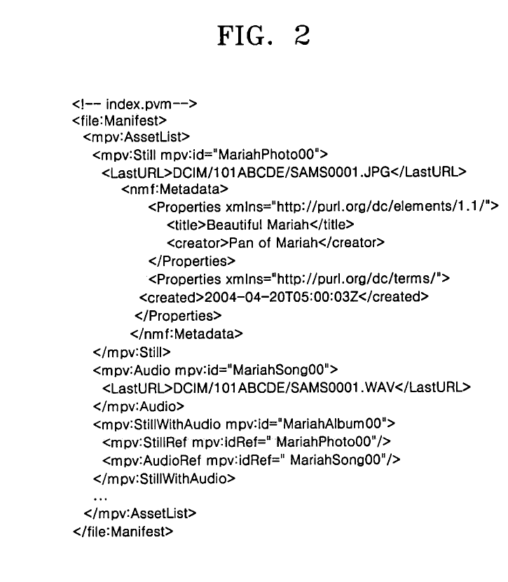

For example, if a file index.pvm is described by the XML as shown in FIG. 2, when a user requests to change a title which is metadata of an asset DCIM/101ABCDE/SAMS001.JPG in which ‘mpv:id’ references “MariahPhoto00”, from “Beautiful Mariah” to “Mariah in Korea”, the metadata editing unit 402 changes the title from “Beautiful Mariah” to “Mariah in Korea”.

If the editing operation requested by the user is complete, the metadata editing unit 402 provides information for the edited asset to the metadata synchronization apparatus 410. The information for the edited asset includes LastURLs of MPV files linked to the edited asset and LastURL of the edited asset. Each LastURL of the MPV files includes a file name of the corresponding MPV file and mpv:id information. For example, to provide information indicating that an edited asset is an asset DCIM/101ABCDE/SAMS0001.JPG, ‘mpv:id’ of the edited asset is “MariahPhoto00” and an MPV file linked to the edited asset is index.pvm, to the metadata synchronization apparatus 410, the metadata editing unit 402 can provide LastURL information of the file index.pvm, and LastURL information of the edited asset to the metadata synchronization apparatus 410.

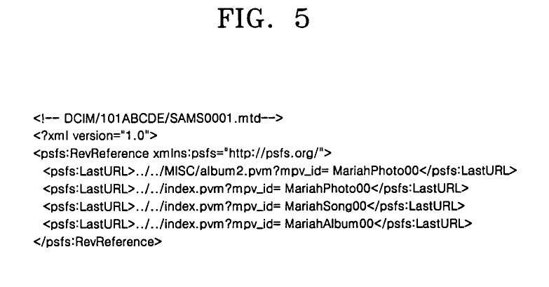

The mtd file unit 403 includes a plurality of files (hereinafter, referred to as mtd files) with the extension of mtd (*.mtd). The mtd file is a backward-link information file in which backward-link information of a content which each asset is referring to is defined. That is, the mtd file is a file in which information of an MPV file linked to an asset referencing (or linking) corresponding content is defined, and can be described by the XML as shown in FIG. 5.

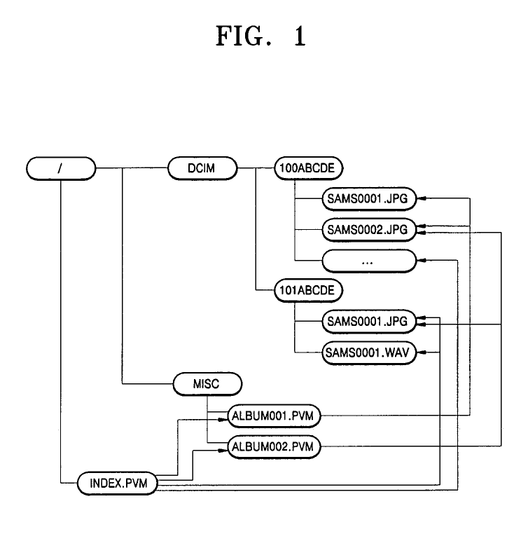

An mtd file shown in FIG. 5 defines information of a plurality of MPV files linked to an asset referencing the content DCIM/101ABCDE/SAMS0001 in the MPV Link shown in FIG. 1. As seen in FIG. 5, it is impossible to recognize the extension of the asset linked to the MPV file on the basis of the MPV file information defined in the mtd file. Since the MPV file information defined in the mtd file represents LastURL of each MPV file, the MPV file information includes a file name and mpv:id information of each MPV file. FIG. 5 shows an mtd file in which four LastURL items are defined as MPV file information.

If the metadata synchronization apparatus 410 receives information for an edited asset from the metadata editing unit 402, the metadata synchronization apparatus 410 searches for an mtd file of the edited asset in the mtd file unit 403, detects an asset referencing the same content as the edited asset on the basis of items defined in the mtd file, and synchronizes metadata of the detected asset with metadata of the edited asset. The asset detected based on the items defined in the mtd file references the same content as the edited asset, however, it is referenced (or linked) by a different file.

The metadata synchronization apparatus 410 includes an mtd file search unit 411, an asset detector 412, and a synchronization processor 413.

If the mtd file search unit 411 receives information for an edited asset from the metadata edit unit 402, the mtd file search unit 411 searches for an mtd file of the edited asset in the mtd file unit 403 using the information for the edited asset. The mtd file is an mtd file with the same file name as the edited asset and the extension of ‘mtd’. That is, the mtd file search unit 411 searches for a corresponding mtd file using LastURL of the edited asset. For example, if LastURL of the received edited asset is /DCIM/101ABCDE/SAMS0001, the mtd file search unit 411 searches for a file /DCIM/101ABCDE/SAMS0001.mtd as a corresponding mtd file. The searched mtd file is transmitted to the asset detector 412.

The asset detector 412 detects an asset referencing the same content as the edited asset in the received mtd file. That is, the asset detector 412 determines whether a different item exists other than items corresponding to the edited asset among items (e.g. LastURL in FIG. 5) defined in the received mtd file.

If a different item exists, the asset detector 412 determines whether or not the different item is an item parsed for synchronizing metadata. The determination can be carried out with reference to separate management information for items parsed for synchronizing metadata or can be carried out using various methods to distinguish parsed items from non-parsed items. If the different item is a non-parsed item, the asset detector 412 obtains LastURL of an asset linked to the different item from the MPV file unit 401. Then, the asset detector 410 determines whether the asset linked to the different item is an asset referencing the same content as the edited asset with reference to the LastURL obtained from the MPV file unit 401. If the asset linked to the different item does not reference the same content as the edited asset, the asset detector 412 completes detecting an asset referencing the same content as the edited asset.

If a plurality of different items exist in the mtd file, it is determined whether each of the different items has been subjected to parsing for synchronizing metadata. Whenever a non-parsed item is detected, an asset linked to the non-parsed item is parsed. Since the mtd file shown in FIG. 5 is defined as a LastURL item, it is determined whether the remaining LastURL items except for a LastURL item corresponding to the edited asset among all LastURL items have been subjected to parsing for synchronizing metadata. If a non-parsed LastURL item exists, LastURL of an asset linked to the non-parsed LastURL item is obtained from the MPV file unit 401 and the LastURL is compared with the LastURL of the edited asset.

Through the determination and comparison, if an asset referencing the same content as the edited asset is detected, the asset detector 412 provides the asset to the synchronization processor 413. If a plurality of assets are detected, the asset detector 412 can transmit the respective detected assets one by one to the synchronization processor 413.

The synchronization processor 413 provides information for the detected asset transmitted from the asset detector 412 to the user interface 420. If the synchronization processor 413 receives a synchronization request from the user interface 420, the synchronization processor 413 synchronizes metadata of the detected asset with the metadata of the edited asset provided from the metadata editing unit 402. Accordingly, in the MPV file unit 401, the detected asset has the same metadata as the edited asset.

After the synchronization processor 413 receives the detected assets from the asset detector 412 and synchronizes the assets, the synchronization processor 413 can request for the asset detector 413 to transmit following detected assets. If no following detected asset is provided from the asset detector 412 to the synchronization processor 413, the synchronization processor 413 completes synchronizing the metadata of the edited asset with that of the detected asset.

The asset detector 412 and the synchronization processor 413 operate for each item defined in the mtd file.

If an editing request from a user is input to the user interface 420, the user interface 420 transmits the editing request to the metadata editing unit 402. Also, if information indicating whether the user wants synchronization for the detected asset is received from the metadata synchronization apparatus 410, the user interface 420 informs the user of the information. If a synchronization request is received from the user, the user interface 420 provides the synchronization request to the synchronization processor 413 of the metadata synchronization unit 410.

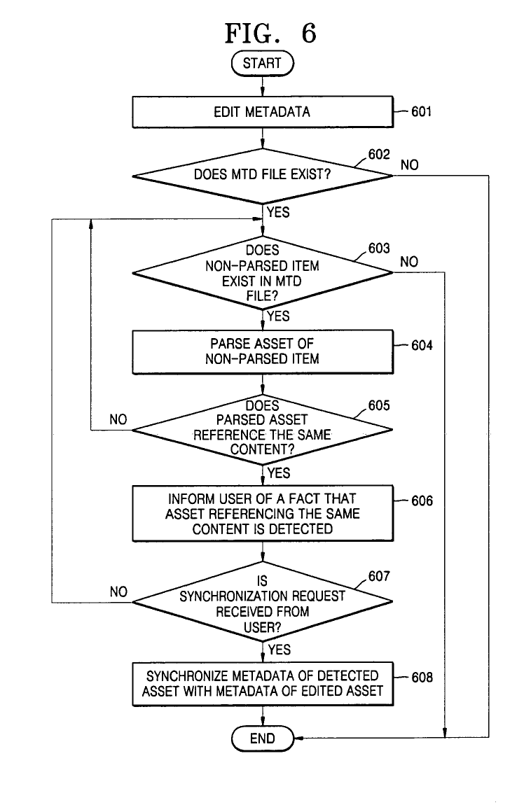

FIG. 6 is a flowchart illustrating a metadata synchronization method according to an embodiment of the present invention.

Referring to FIG. 6, if metadata is edited as described above with reference to the metadata editing unit 402 of FIG. 4 (step 601), it is determined whether an mtd file of an asset with the edited metadata exists in the mtd file unit 403 (step 602).

If the mtd file exists in the mtd file unit 403, it is determined whether an item not subjected to parsing for synchronizing metadata exists among the remaining items except for items corresponding to the edited asset in items defined in the mtd file (step 603). That is, it is determined whether there is an item not subjected to parsing for determining whether or not an asset linked to the remaining items is an asset referencing the same content as the edited asset.

If a non-parsed item exists among the remaining items defined in the mtd file, an asset linked to the non-parsed item is parsed (step 604). That is, referring to FIG. 5, LastURL of the linked asset is detected from the MPV file unit 401 on the basis of LastURL of the non-parsed item. If a plurality of non-parsed items exist, assets linked to the non-parsed items can be parsed in an order of items defined in the mtd file.

Then, it is determined whether the parsed asset references the same content as the edited asset (step 605). If LastURL of a parsed asset is equal to LastURL of the edited asset, it is determined that the parsed asset references the same content as the edited asset. However, if the LastURL of the parsed asset is different from the LastURL of the edited asset, it is determined that the parsed asset references different content from the edited asset.

If the parsed asset does not reference the same content as the edited asset, the process is returned to step 603. On the contrary, if the parsed asset references the same content as the edited asset, a fact that a different asset referencing the same content is detected, is reported to the user (step 606).

Successively, if a synchronization request is received from the user (step 607), metadata of the detected asset is synchronized with the metadata of the edited asset. However, if no synchronization request is received from the user, the process is returned to step 603.

If in step 602, no mtd file corresponding to the edited asset exists in the mtd file unit 403, or if in step 603, no non-parsed item exists in the mtd file, synchronizing metadata of assets referencing the same content is complete.

As described above, according to the present invention, since if metadata of an asset is edited, an asset referencing the same content as the edited asset is detected with reference to a backward link information file of the asset with the edited metadata and metadata of the detected asset is synchronized with the metadata of the edited asset, it is possible to easily synchronize metadata of assets linked to a plurality of MPV files referencing the same content and prevent contradiction between metadata of assets linked to the plurality of MPV files referencing the same content.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for synchronizing metadata, the method comprising:
editing a metadata of a first asset;
detecting a second asset referencing a same content as the first asset using a backward-link information file of content which the first asset refers to; and
synchronizing metadata of the second asset with the edited metadata of the first asset.

2. The method of claim 1, further comprising:
if the second asset is detected, informing a user that the second asset is detected; and
if a synchronization request for the second asset is received from the user, performing the synchronizing the metadata of the second asset with the edited metadata of the first asset.

3. The method of claim 2, wherein if a plurality of non-parsed items exist in the backward-link information file, the detecting, the informing, and the synchronizing are performed for each item.

4. The method of claim 1, wherein, if a plurality of non-parsed items exist in the backward-link information file, the detecting and the synchronizing are performed for each item.

5. A method for synchronizing metadata of assets in a system including an MPV file unit and a backward-link information file unit, the method comprising:
editing metadata of a first asset;
searching for a backward-link information file of a content which the first asset refers to, in the backward-link information file unit;
determining whether a second asset detected from the MPV file unit based on the backward-link information file references a same content as the first asset; and
if the second asset references the same content as the first asset, synchronizing metadata of the second asset with the edited metadata of the first asset.

6. The method of claim 5, further comprising:
if the second asset references the same content as the first asset, reporting detection of the second asset to a user; and
if a synchronization request is received from the user, performing the synchronizing the metadata of the second asset with the edited metadata of the first asset.

7. An apparatus for synchronizing metadata, the apparatus comprising:
an MPV file unit having information for at least one asset;
a metadata editing unit editing metadata of a first asset;
a backward-link information file unit having a backward-link information file of at least one content;
a search unit searching for a backward-link information file of a content which the first asset refers to, in the backward-link information file unit based on information of the first asset provided from the metadata editing unit;
an asset detector detecting a second asset referencing the same content as the first asset using the searched backward-link information file and the information included in the MPV file unit; and
a synchronization processor synchronizing metadata of the second asset with the edited metadata of the first asset.

8. The apparatus of claim 7, wherein the synchronization processor informs a user that the second asset is detected, and synchronizes the edited metadata of the second asset with the edited metadata of the first asset if a synchronization request is received from the user.

9. The apparatus of claim 7, wherein, if the backward-link information file has a plurality of non-parsed items, the asset detector detects an asset referencing the same content as the first asset for each item.

10. A computer-readable medium having embodied thereon a computer program for executing a method for synchronizing metadata,
the method comprising:
editing metadata of a first asset;
detecting a second asset referencing a same content as the first asset using a backward-link information file of a content which the first asset refers to; and
synchronizing metadata of the second asset with the edited metadata of the first asset.
